(19) United States
(12) Patent Application Publication
(10) Pub. No.: US 2009/0153989 A1
(43) Pub. Date: Jun. 18, 2009

(54) OPTICAL FILTER FOR DISPLAY DEVICE

(75) Inventors: Jin-soo An, ChungCheongNam-Do (KR); Jechoon Ryoo, ChungCheongNam-Do (KR); Jeong Hong Oh, ChungCheongNam-Do (KR); Hongik Kim, ChungCheongNam-Do (KR)

Correspondence Address: MCDERMOTT WILL & EMERY LLP, 600 13TH STREET, N.W., WASHINGTON, DC, 20005-3096, US

(73) Assignee: SAMSUNG CORNING PRECISION GLASS CO., LTD.

(21) Appl. No.: 12/332,158

(22) Filed: Dec. 10, 2008

(30) Foreign Application Priority Data
Dec. 14, 2007 (KR) 10-2007-0131465

(51) Int. Cl. G02B 5/22

(52) U.S. Cl. 359/885

(57) ABSTRACT

An optical filter for a display device includes a transparent substrate; an electromagnetic shielding layer in which a high refractive metal oxide layer and a metallic layer are layered, the electromagnetic shielding layer being layered on the transparent substrate; and a grounding conductive film layer for grounding the electromagnetic shielding layer, the a grounding conductive film layer being layered on the electromagnetic shielding layer. The optical filter can improve the ability to block electromagnetic waves.

### CROSS-REFERENCE TO RELATED APPLICATION

This application claims the benefit of Korean Patent Application No. 2007-0131465 filed on Dec. 14, 2007, in the Korean Intellectual Property Office, the disclosure of which is incorporated herein by reference.

### BACKGROUND OF THE INVENTION

1. Field of the Invention

The present invention relates to an optical filter for a display device, more particularly, to an optical filter for a display device which has a grounding conductive film layer to improve the ability to block electromagnetic waves.

2. Description of the Related Art

Display devices include televisions, monitors of personal computers, portable display devices, and so on. Display devices are recently getting larger in size and thinner.

Accordingly, flat panel display (FPD) devices such as plasma display panel (PDP) devices, liquid crystal display (LCD) devices, field emission display (FED) devices, and organic light emitting display (OLED) devices take the place of cathode ray tube (CRT) devices, which was representative of display devices.

Hereinafter, PDP devices and a filter therefor will be exemplified but the present invention is not limited thereto. For example, a filter according to the present invention can be used for large sized display devices such as OLED devices, LCD devices and FED devices; small sized display devices such as Personal Digital Assistance (PDA) devices, display devices for small sized game machines, display devices for small mobile phones; and flexible display devices.

Among display devices, PDP devices are in the limelight since they have excellent display characteristics such as high luminance, a high contrast ratio, low after-image, and a wide viewing angle.

PDP devices cause gas discharge between electrodes by applying a direct or alternating voltage to the electrodes, the gas discharge causes ultraviolet rays, the ultraviolet rays activates a fluorescent material in the PDP devices, and thereby light is generated. PDP devices display images by using the generated light.

However, a PDP device has drawbacks in that a large amount of electromagnetic waves and near infrared rays is emitted due to its intrinsic characteristics. The electromagnetic waves and near infrared rays emitted from the PDP device may have a harmful effect to the human body, and cause malfunction of precision appliances such as a cellular phone and a remote controller. Further, the PDP device has a high surface reflectance and has lower color purity than CRT devices due to orange color light emitted from gas such as He or Xe.

Therefore, the PDP device uses a PDP filter in order to block the electromagnetic waves and near infrared rays, reduce the light reflection, and improve the color purity. The PDP filter is installed in front of a panel assembly. Generally, in order to form the PDP filter, a plurality of functional layers such as an electromagnetic shielding layer, a near infrared ray blocking layer, a neon peak absorbing layer, etc. adheres to each other or bonds with each other.

However, the conventional PDP filter has the following drawbacks.

The electromagnetic shielding layer can be classified broadly into two types. One is an electromagnetic shielding layer of a mesh type having a mesh pattern of metal. The other is an electromagnetic shielding layer of a multi-layered type having a metallic layer therein.

The former has a merit that its electric resistance is low so that it has better ability to block electromagnetic waves than the latter. However, the former has a low transparency and can cause a moiré phenomenon due to geometrical interference with the panel assembly. In addition, the former is expensive so that the cost of goods increases.

On the other hand, the latter is worse ability to block electromagnetic waves than the former. Accordingly, the latter is required to improve the electromagnetic shielding ability. Research on how to improve the ability is going on.

### SUMMARY OF THE INVENTION

The present invention has been made to solve the foregoing problems with the prior art, and therefore an object of the present invention is to provide an optical filter of a multi-layered type for a display device having improved ability to block electromagnetic waves.

The objects that the present invention intends to achieve are not limited to the above-mentioned objects, and other objects which are not mentioned, will be apparently understood from below by those skilled in the art.

In one aspect of the invention, there is provided an optical filter for a display device including a transparent substrate; an electromagnetic shielding layer in which a high refractive metal oxide layer and a metallic layer are layered, the electromagnetic shielding layer being layered on the transparent substrate; and a grounding conductive film layer for grounding the electromagnetic shielding layer, the grounding conductive film layer being layered on the electromagnetic shielding layer.

### BRIEF DESCRIPTION OF THE DRAWINGS

The above and other objects, features and advantages of the present invention will be more clearly understood from the following detailed description provided in conjunction with the accompanying drawings, in which:

FIG. 1 is a cross-sectional view illustrating an optical filter according to an embodiment of the present invention;

FIG. 2 is a cross-sectional view illustrating an electromagnetic shielding layer which can be used in the optical filter in FIG. 1; and

FIG. 3 is a cross-sectional view illustrating another electromagnetic shielding layer which can be used in the optical filter in FIG. 1.

### DETAILED DESCRIPTION OF THE EXEMPLARY EMBODIMENT

The present invention will now be described more fully hereinafter with reference to the accompanying drawings, in which exemplary embodiments thereof are shown.

A PDP optical filter is arranged in front of a panel assembly. The PDP filter can be disposed apart from the panel assembly or in contact with the panel assembly.

The PDP filter includes an electromagnetic shielding layer which is made of a material with good conductivity and is formed on a transparent substrate. Although not shown, the electromagnetic shielding layer can be grounded through a grounding conductive film layer and a cover to case. That is, before electromagnetic waves caused by the panel assembly reaches a viewer, they are discharged through the electromagnetic shielding layer, the grounding conductive film layer and the cover to the case.

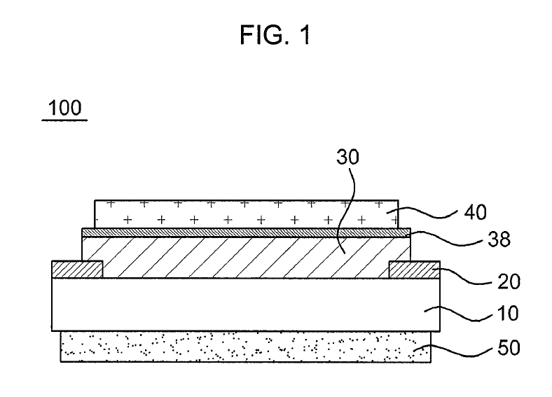

FIG. 1 is a cross-sectional view illustrating an optical filter 100 for a display device according to one embodiment of the present invention.

Referring to FIG. 1, the optical filter 100 includes a transparent substrate 10, an electromagnetic shielding layer 30 formed on the rear surface of the transparent substrate 10, a grounding conductive film layer 38 which is layered on the electromagnetic shielding layer 30 and earths the electromagnetic shielding layer 30 so as to discharge the electromagnetic waves outwards.

In addition, the optical filter 100 can further includes a first functional layer 40 formed on the rear surface of the grounding conductive film layer 38 and a second functional layer 50 formed on the front surface of the transparent substrate 10.

The grounding conductive film layer 38 solves a problem that a grounding electrode according to a conventional filter can not conduct the electricity well to discharge the electricity outwards well, thereby improving the ability of block the electromagnetic waves

The grounding conductive film layer 38 is a metallic film layer or a conductive metal oxide film layer. For example, the grounding conductive film layer 38 can include Ag, Au, Cu, ITO, AZO, GAZO, AZO, ATO, SbO2, In2O3, SnO2, ZnO2, TiO2, ZrO2, CeO2, Al2O3, La2O3, Ho2O3, or the like.

Of course, as shown in FIG. 1, the optical filter 100 according to the present invention may include such a grounding electrode as a conventional optical filter includes. In this case, since the optical filter 100 includes both the grounding conductive film layer 38 and the grounding electrode 20, the ability to block the electromagnetic waves can be improved still more.

The grounding electrode 20 can be made of silver paste. The grounding electrode 20 is also connected to ground to discharge outwards the electromagnetic waves which otherwise travel through the optical filter 100. A black ceramic (not shown) can be provided between the grounding electrode 20 and the transparent substrate 10. The black ceramic can be formed along a periphery of the screen of the display device.

The transparent substrate 10 can be made of semi-tempered glass or transparent polymer resin such as polycarbonate (PC), polyethylene terephthalate (PET), etc.

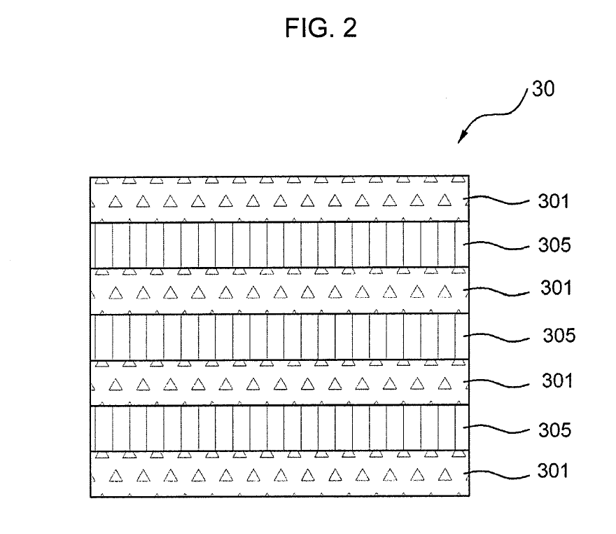

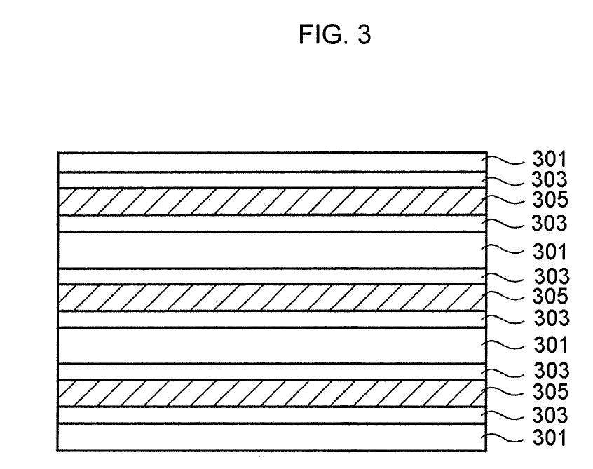

The electromagnetic shielding layer 30 can be formed by layering a high refractive metal oxide layer 301 and a metallic layer 305. The electromagnetic shielding layer 30 can further include a conductive metal oxide layer, as shown in FIG. 3. Referring to FIGS. 2 and 3, the electromagnetic shielding layer 30 will be described in more detail.

The first functional layer 40 includes a protection layer. The first functional layer 40 adheres to the grounding conductive film layer 38 via pressure sensitive adhesive (PSA) so as to prevent the oxidation of the grounding conductive film layer 38 and the sticking of dirt on the grounding conductive film layer 38.

The first functional layer 40 can include a color compensation layer. The color compensation layer includes a colorant to compensate the color of the light emitted from the panel assembly.

The second functional layer 50 is disposed in front of the transparent substrate 10. The second functional layer 50 can include an anti-reflection layer, etc. The anti-reflection layer is disposed near a viewer to prevent the reflection of external light and thereby the degradation of display quality of the display device.

FIG. 2 is a cross-sectional view in which an electromagnetic shielding layer 30 which can be used in the optical filter 100 in FIG. 1 is illustrated in detail.

Referring to FIG. 2, the electromagnetic shielding layer 30 is fabricated through the following process. First, a high refractive metal oxide layer 301 is layered on a transparent substrate, and then a metallic layer 305, a high refractive metal oxide layer 301, a metallic layer 305, a high refractive metal oxide layer 301, a metallic layer 305 and a high refractive metal oxide layer 301 are layered in the order named.

The number and arrangement of the high refractive metal oxide layers 301 and the metallic layers 305 forming the electromagnetic shielding layer 30 are not limited to those shown in FIG. 2. As shown in FIG. 3, the electromagnetic shielding layer 30 can further include a conductive metal oxide layer.

FIG. 3 is a cross sectional view in which another electromagnetic shielding layer which can be used in the filter 100 in FIG. 1 is illustrated in detail.

The electromagnetic shielding layer is fabricated through the following process. A first high refractive metal oxide layer, a first conductive metal oxide layer, a metallic layer 305 and a second conductive metal oxide layer are layered on the transparent substrate in the order named one or more times, preferably at least three times and then a second high refractive metal oxide layer is layered as the outermost layer.

The high refractive metal oxide layer 301, that is, the first high refractive metal oxide layer and the second high refractive metal oxide layer can include Nb₂O₅. The conductive metal oxide layer 303, that is, the first conductive metal oxide layer and the second conductive metal oxide layer can include AZO.

The high refractive metal oxide layer 301 can be made of Niobium oxide (Nb₂O₅) only or can include a small amount of other materials such as TiO₂, Ta₂O₅, ZrO₂, CeO₂, ZnS, etc. together with Niobium oxide.

The first high refractive metal oxide layers and the second high refractive metal oxide layer can have the same composition or different compositions.

In order to reduce the reflectance of visible light and widen the wavelength range in which low reflectance can be obtained, the first high refractive metal oxide layer nearest to the transparent substrate and the outermost high refractive metal oxide layer, that is, the second high refractive metal oxide layer can be thinner than (especially, have about half the thickness of) other first high refractive metal oxide layers.

On the first high refractive metal oxide layer, the first conductive metal oxide layer which contains ZnO as a principal constituent is formed. The first conductive metal oxide layer protects the metallic layer 305 formed on the first conductive metal oxide layer to improve durability. In addition, the first conductive metal oxide layer increases electrical conductivity which the metallic layer 305 provides, thereby improving electromagnetic shielding ability. The first conductive metal oxide layer can be made of AZO, an oxide containing ZnO and a small amount of Al or Al₂O₃. For example, AZO can contain 90˜99.9% of ZnO and 10˜0.1% of Al₂O₃, but the present invention is not limited thereto.

The high refractive metal oxide layer has a larger refractive index than air having a refractive index of about 1.5, and preferably has a refractive index of more than 2.

Then, on the first conductive metal oxide layer, the metallic layer 305 is formed. The metallic layer 305 can be made of silver or silver alloy containing silver as a principal constituent, e.g. silver of at least 90 weight percent. Silver has excellent ductility and conductivity. Even after silver is processed into a film form, it keeps its own conductivity. In addition, silver is cheap and has a low absorptivity to visible light, which enables the optical filter to have high transparency.

The metallic layers 305 can have the same composition or different compositions.

The second conductive metal oxide layer functions as a blocker which prevents the metallic layer 305 from losing its own electric conductivity due to oxygen plasma in the next step of forming the high refractive metal oxide layer 301. If the high refractive metal oxide layer 301 is formed directly on the metallic layer 305 by a direct current sputtering, the metallic layer 305 is apt to suffer damage due to oxygen plasma. Accordingly, in order to prevent the damage, the second conductive metal oxide layer is formed by using Al added ZnO, pure ZnO, SnO₂, ITO, etc.

However, in some embodiments, the second conductive metal oxide layer can be excluded from the optical filter.

The conductive metal oxide layers 303 can have the same composition or different compositions.

The conductive metal oxide layer 303 obstructs surface plasmons from arising at the boundary between the metallic layer 305 and the high refractive metal oxide layer 301 and thereby reduces the loss of visible light in the electromagnetic shielding layer due to light absorption caused by the surface plasmons. At the same time, the conductive metal oxide layer 303 reduces reflectance of visible light and widens a wavelength range in which low reflectance can be obtained.

Preferred embodiments of the present invention have been described for illustrative purposes. Those skilled in the art will appreciate that various modifications, additions and substitutions are possible, without departing from the scope and spirit of the invention as disclosed in the accompanying claims.

What is claimed is:

1. An optical filter for a display device comprising:
a transparent substrate;
an electromagnetic shielding layer in which a high refractive metal oxide layer and a metallic layer are layered, the electromagnetic shielding layer being layered on the transparent substrate; and
a grounding conductive film layer for grounding the electromagnetic shielding layer, the grounding conductive film layer being layered on the electromagnetic shielding layer.

2. The optical filter for the display device of claim 1,
wherein the grounding conductive film layer is a metallic film layer or a conductive metal oxide film layer.

3. The optical filter for the display device of claim 1 further comprising a grounding electrode for grounding the electromagnetic shielding layer,
wherein the grounding electrode is disposed between the transparent substrate and the electromagnetic shielding layer.

4. The optical filter for the display device of claim 3,
wherein the grounding electrode is disposed at a periphery of the electromagnetic shielding layer.

5. The optical filter for the display device of claim 3,
wherein the grounding electrode includes silver paste.

6. The optical filter for the display device of claim 1 further comprising a functional layer,
wherein the functional layer is layered on the grounding conductive film layer, and includes a protection layer.

7. The optical filter for the display device of claim 6,
wherein the functional layer includes a color compensation layer.

8. The optical filter for the display device of claim 1,
wherein the electromagnetic shielding layer further comprises a first conductive metal oxide layer and a second conductive metal oxide layer,
the high refractive metal oxide layer comprises a first high refractive metal oxide layer and a second high refractive metal oxide layer, and
in the electromagnetic shielding layer, the first high refractive metal oxide layer, the first conductive metal oxide layer, the metallic layer and the second conductive metal oxide layer are layered in the order named one or more times and then the second high refractive metal oxide layer is layered last.

9. The optical filter for the display device of claim 8,
wherein the high refractive metal oxide layer includes Nb₂O₅, and the first conductive metal oxide layer and the second conductive metal oxide layer include AZO.
